(19) United States
(12) Patent Application Publication
(10) Pub. No.: US 2022/0325112 A1
(43) Pub. Date: Oct. 13, 2022

(54) CLAY SHEETS BASED OXIDATION BARRIER COATING FOR METALS

(71) Applicant: Northwestern University, Evanston, IL (US)

(72) Inventors: Limei Liu, Evanston, IL (US); Jiaxing Huang, Wilmette, IL (US)

(21) Appl. No.: 17/715,637

(22) Filed: Apr. 7, 2022

Related U.S. Application Data
(60) Provisional application No. 63/172,502, filed on Apr. 8, 2021.

(51) Int. Cl. C09D 5/08; C09D 7/48; C09D 7/62; C04B 41/50; C04B 41/45; C04B 35/622

(52) U.S. Cl. CPC C09D 5/084; C09D 7/48; C09D 7/62; C04B 41/5037; C04B 41/4535; C04B 35/62222

(57) ABSTRACT

Methods of forming oxidation barriers are provided. An illustrative method comprises applying a clay mineral coating composition comprising a solvent and exfoliated clay mineral sheets, e.g., exfoliated vermiculite sheets, to a surface of a substrate; and removing solvent from the clay mineral coating composition as-applied to the surface, thereby forming a coating comprising the exfoliated clay mineral sheets on the surface. The oxidation barriers are also provided.

### CROSS-REFERENCE TO RELATED APPLICATIONS

The present application claims priority to U.S. provisional patent application No. 63/172,502 that was filed Apr. 8, 2021, the entire contents of which are incorporated herein by reference.

### BACKGROUND

Thermal barrier coating allows metals to be used in high temperature and oxidative environments that would otherwise quickly alter their chemical composition and degrade their properties, thus protecting metals during harsh materials processing and extending their service lifetime. For various industrial applications, metal alloys, metal oxides, silicates, polymers and their combinations have been developed for high-durability anti-oxidation coatings over wide temperature ranges.

### SUMMARY

Provided are vermiculite coatings and related methods.

The Example, below, demonstrates the formation of solution-processed barrier coatings using “down to earth” two-dimensional (2D) materials made from exfoliated vermiculite (VMT) particles. Compared with graphene and other 2D materials, vermiculite sheets come from an abundant, low-cost clay mineral, can be exfoliated into very high aspect ratio sheets using a relatively benign process in water without redox chemical reactions, and they have high (electro-)chemical/thermal stability. To improve the exfoliation yields, a two-step mechanical-chemical approach was developed. First, the as-received, thermally expanded vermiculite particles were pulverized using a kitchen blender without adding solvents, which broke the millimeter-sized particles into fine powers. Next the powders were further exfoliated by ionic exchange reactions and hydrogen peroxide (H₂O₂) bubbling treatment, resulting in a high yield of monolayer to few-layer vermiculite sheets in the supernatant. Cu foil was chosen as the model metal for testing the vermiculite coatings. The exfoliated vermiculite sheets can be spray-coated directly on Cu foils without any additives (such as binders) to form a continuous protective coating against thermal oxidation at 400° C. for a full day.

In embodiments, a method of forming an oxidation barrier comprises applying a clay mineral coating composition comprising a solvent and exfoliated clay mineral sheets, e.g., exfoliated vermiculite sheets, to a surface of a substrate; and removing solvent from the clay mineral coating composition as-applied to the surface, thereby forming a coating comprising the exfoliated clay mineral sheets on the surface.

In embodiments, an oxidation barrier comprises a coating comprising exfoliated clay mineral sheets, e.g., exfoliated vermiculite sheets, on a surface of a substrate.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIGS. 1A-1D show the exfoliation of mineral vermiculite particles. FIG. 1A shows that thermally expanded vermiculite particles were first mechanically pulverized by a kitchen blender to reduce their particle size to sub-millimeter scale, which were then further exfoliated by a two-step ionic exchange process to yield the final dispersion of mono- to few-layer sheets. FIGS. 1B-1D show AFM images of a LB film of exfoliated vermiculite sheets, showing lateral dimensions from a few microns to tens of microns. The line scan in FIGS. 1C-1D shows that the thickness of a single sheet is less than 2 nanometers.

FIG. 2A shows an image of a Cu foil with the bottom half coated with vermiculite sheets by spray-coating. The coating appears to be smooth, continuous, highly uniform, and translucent. The height profile in the inset shows that the thickness of the coating is around 1 μm. SEM images of the top surface of (FIG. 2B) bare Cu foil and (FIG. 2C) vermiculite coated Cu foil are also shown. SEM images of the top surface of (FIG. 2D) bare Cu foil and (FIG. 2E) vermiculite coated Cu foil after 200° C./24 h oxidation in air are also shown.

FIG. 3A shows tensile stress-strain curves and FIG. 3B shows tensile strength for uncoated Cu foils and vermiculite coated Cu foils without treatment and after annealing for 24 h at different temperatures.

FIG. 4 shows the Vickers hardness for Cu and vermiculite coated Cu foils after annealing for 24 h at different temperatures in air.

### DETAILED DESCRIPTION

Clay mineral coating compositions are disclosed which may be used to provide clay mineral coatings on substrate surfaces to render those surfaces resistant to thermal oxidation. Methods of forming and using the clay mineral coating compositions are also disclosed. The clay mineral coating compositions, coatings, and coated surfaces are also encompassed.

Methods of forming a clay mineral coating composition are provided. In embodiments, such a method comprises pulverizing clay mineral particles; exposing the pulverized clay mineral particles to a first salt solution; exposing the pulverized clay mineral particles to a second salt solution; and exposing the pulverized clay mineral particles to a peroxide. The clay mineral particles may be vermiculite particles. The vermiculite particles may be thermally expanded, which refers to vermiculite particles which have been subjected to thermal shock as described in the Example, below.

Pulverizing refers to subjecting the clay mineral particles to a mechanical force to reduce the size of the particles. Pulverizing may be carried out using various techniques, including blending for a period of time. The conditions used, e.g., blending speed, time, may be optimized depending upon the desired size for the pulverized clay mineral particles. The pulverizing may be accomplished without the use of any solvents, i.e., only the solid clay mineral particles are pulverized. Illustrative conditions are provided in the Example, below.

The pulverized clay mineral particles are then exposed to first and second salt solutions. The exposure to the two salt solutions is generally accomplished sequentially. The first salt solution comprises a first type of cation while the second salt solution comprises a second type of cation. The first and second types of cations are chemically different from one another. Exposure to the salt solutions takes place under conditions such that interlayer cations of the pulverized clay mineral particles are exchanged for cations of the first type and cations of the second type. Various first and second salt solutions may be used, depending upon the desired cations to be exchanged and the clay mineral particles being used. In embodiments, the first salt solution comprises a sodium salt, e.g., NaCl. In embodiments, the second salt solution comprises a lithium salt, e.g., LiCl. The first and second salt solutions are generally aqueous solutions. The conditions under which the exposure occurs refers to salt concentration, temperature, time, mixing conditions. These parameters may be optimized to facilitate the ion exchange process. Illustrative conditions are provided in the Example, below. The material that results from exposure to the first and second salt solutions may be referred to as “ion exchanged clay mineral sheets.” These ion exchanged clay mineral sheets will have, incorporated therein, interlayer cations comprising the first and second types of cations (at least some original interlayer cations of the clay mineral may also be present).

The ion exchanged clay mineral sheets are then exposed to a peroxide. This exposure results in oxygen evolution and facilitates exfoliation of individual monolayers of the clay mineral. Various peroxides may be used, e.g., H₂O₂. The peroxide is generally provided in a solvent, e.g., water. The conditions under which the exposure to the peroxide occurs refers to peroxide concentration, temperature, time, mixing conditions. These parameters may be optimized to facilitate oxygen evolution/exfoliation. Illustrative conditions are provided in the Example, below. The material that results from exposure to the peroxide may be referred to as “exfoliated clay mineral sheets.” As above, these exfoliated clay mineral sheets will have, incorporated therein, interlayer cations comprising the first and second types of cations (at least some original interlayer cations of the clay mineral may also be present).

Filtering, washing, and/or centrifugation may be used between steps of the method as described in the Example, below.

The exfoliated clay mineral sheets are two-dimensional (2D) structures having lateral, in-plane dimensions that are significantly greater than the dimension perpendicular to the plane (i.e., thickness). The term “sheet” encompasses a monolayer of the clay mineral as well as a few (e.g., 2-5) monolayers of the clay mineral. Using vermiculite as an example, a monolayer (i.e., single layer) of vermiculate refers to a magnesium aluminosilicate compound composed of a single Mg-based octahedral sublayer sandwiched between two tetrahedral silicate sublayers. An exfoliated vermiculite sheet may be composed of a monolayer of vermiculate or up to a few (e.g., 2-5) such monolayers. The lateral dimensions of the exfoliated clay mineral sheets are not particularly limited, but may be on the order of from a few (2-5) μm to a few tens (20-50) of μm. The thicknesses of the exfoliated clay mineral sheets are those which correspond to a monolayer to up to a few monolayers of the clay mineral, e.g., from 1 nm to 10 nm.

The clay mineral coating composition comprises the exfoliated clay mineral sheets and generally, a solvent. Water, an alcohol, or combinations thereof, may be used as the solvent. The clay mineral coating composition may be in the form of a colloidal suspension of the exfoliated clay mineral sheets in the solvent. Other additives may be used but are not required. In embodiments, no additives (e.g., binders) are used.

Methods of forming an oxidation barrier using the clay mineral coating compositions are also provided. In embodiments, such a method comprises applying the clay mineral coating composition to a surface of a substrate to form a coating comprising exfoliated clay mineral sheets thereon. Any type of thin film coating technique may be used, e.g., spraying. The method generally comprises removing solvent from the as-applied clay mineral coating composition. This may be facilitated by heating, including by heating the surface of the substrate (before, during, or after the application step). Application conditions may be optimized to facilitate formation of the coating as well as to achieve a desired thickness and uniformity. Generally, the coatings are relatively thin (e.g., from 1 μm to 100 μm) and uniform.

The coatings comprising the exfoliated clay mineral sheets render the underlying substrate surfaces resistant to thermal oxidation. This may be demonstrated by the coatings exhibiting no to minimal changes in thickness, no to minimal incorporation of oxygen, no to minimal change in tensile strength, hardness, or conductivity, after exposure to oxygen (e.g., air) and heat (e.g., 300° C. or 400° C.) for a period of time (e.g., 24 hours). By “no change or minimal change” it is meant obtaining results within the values obtained for the exposed illustrative coatings as described in the Example, below.

The clay mineral coating compositions may be applied to any surface in need of oxidation resistance. Metal surfaces, e.g., copper surfaces, may be used.

The clay mineral coating compositions comprising the exfoliated clay mineral sheets and the resulting coatings and coated surfaces are all encompassed by the present disclosure. In embodiments, the clay mineral coating composition consists of the exfoliated clay mineral sheets and a solvent. In embodiments, the clay mineral coating consists of the exfoliated clay mineral sheets. These embodiments do not preclude the presence of a small amount of impurities in the coating compositions/coatings inherent to the techniques described herein. These embodiments exclude the presence of any binders in the coating compositions/coatings. Even without such binders, the resulting coatings significantly improve the resistance of the underlying surfaces to thermal oxidation.

### EXAMPLE

### Introduction

High-temperature barrier coatings protect metals and alloys from oxidization, delay property degradation, and increase their service lifetime. Here, a vermiculite clay-based oxidation-resistant coating on metal is demonstrated, using copper as an example. Dispersion of few-layer vermiculite sheets with lateral dimensions in the range of microns to tens of microns were obtained in a two-step mechanical-chemical exfoliation approach, using vermiculite particles as the starting material. The dispersion of these high aspect ratio 2D sheets can be directly spray-coated on Cu foils to form a continuous and transparent thermal barrier film without the need for any binder materials. After heating in air at 400° C. for 24 h, vermiculite protected Cu foils did not show significant sign of oxidation or degradation in mechanical and electrical properties, while uncoated Cu foils were completely destroyed.

### Experimental

### Materials

Thermally expanded vermiculite particles, sodium chloride, lithium chloride, and hydrogen peroxide (H₂O₂, 30%) were purchased from Sigma Aldrich and used as received. Cu foils (20-25 μm thick) were purchased from Alfa Aesar.

### Preparation of Vermiculite Sheets and Coatings

The thermally expanded vermiculite crystals were subjected to a two-step ion-exchange exfoliation process. 5 g of thermally expanded vermiculite crystals (millimeter to centimeter in size) was pulverized into sub-millimeter fine powders (<1 mm³) using a kitchen blender (900 W, for 1 min), followed by soaking in a saturated boiling sodium chloride (NaCl) solution under reflux for 24 hours. Then they were vacuum filtrated and repeatedly washed with deionized (DI) water and ethanol. The resulting product was again soaked in 2 M boiling lithium chloride (LiCl) solution under reflux for an additional 24 hours, followed by vacuum filtration and extensive washing with DI water and ethanol. Next, the product was re-dispersed into 30% v/v of H₂O₂ and it was allowed to bubble overnight with the help of magnetic stirring. Finally, the water/ethanol-washed suspension was centrifuged at 5,000 rpm for 10 min to remove thick vermiculite sheets. The yield of vermiculite sheets was calculated to be ˜40% by calculating the weight ratio of the exfoliated products to the raw material.

Monolayers of exfoliated vermiculite sheets were prepared by Langmuir-Blodgett (LB) assembly for microscopy observation. Specifically, the trough (10 cm×25 cm, Nima Technology, model 116) was carefully cleaned with chloroform and then filled with DI water. Vermiculite sheets in water solution were slowly spread onto the water surface dropwise at a speed of 100 μL/min up to a total of 8-12 mL. Surface pressure was monitored using a tensiometer attached to a Wilhelmy plate. A faint brown vermiculite film became visible on the water at the end of the compression.

A colloidal dispersion (1 ml) of the exfoliated sheets was spray-coated onto Cu foils with size of ˜4 cm², which were put on a 200° C. hotplate. Note that Cu foils were heated at 200° C. for only 1 min while the coating process completed, which did not affect their properties. The thickness of the coatings was found to be about 1 μm. Next, the uncoated and vermiculite coated Cu foils were heated in a furnace at temperatures between 200-400° C. for 24 hours. To remove the oxide layers after oxidation, the Cu foils were washed with warm acetic acid (60° C.) for 15 minutes, followed by rinsing with DI water.

### Characterization

The thickness of the exfoliated vermiculite sheets was determined by a Bruker Dimensional Icon AFM system in the tapping mode. The cross-sectional morphology and energy-dispersive X-ray spectroscopy was examined by a SEM system (Hitachi 8030, Japan). The thickness of the vermiculite coatings was measured by a surface profiler (Dektak 150, Veeco, USA). Optical images were collected by a Nikon Eclipse E200 microscope. Mechanical tensile properties of the Cu and vermiculite coated Cu foils were evaluated under uniaxial tension using a dynamic mechanical analyzer (EltroForce 5500, TA Instruments, USA). A microhardness tester (KB 5BVZ) was used to measure H_{V} with a diamond Vickers indenter. H_{V} was determined from H_{V}=1,854.4F/d², where F (in Newtons) is the applied load and d (in μm) is the arithmetic mean of the two diagonals (d₁ and d₂) of the Vickers indentation. The conductance of uncoated and vermiculite coated Cu foils before and after different oxidation conditions were measured using a Keithley 2400 source meter. Two copper clips were used to make electric contacts with the foils.

### Results and Discussion

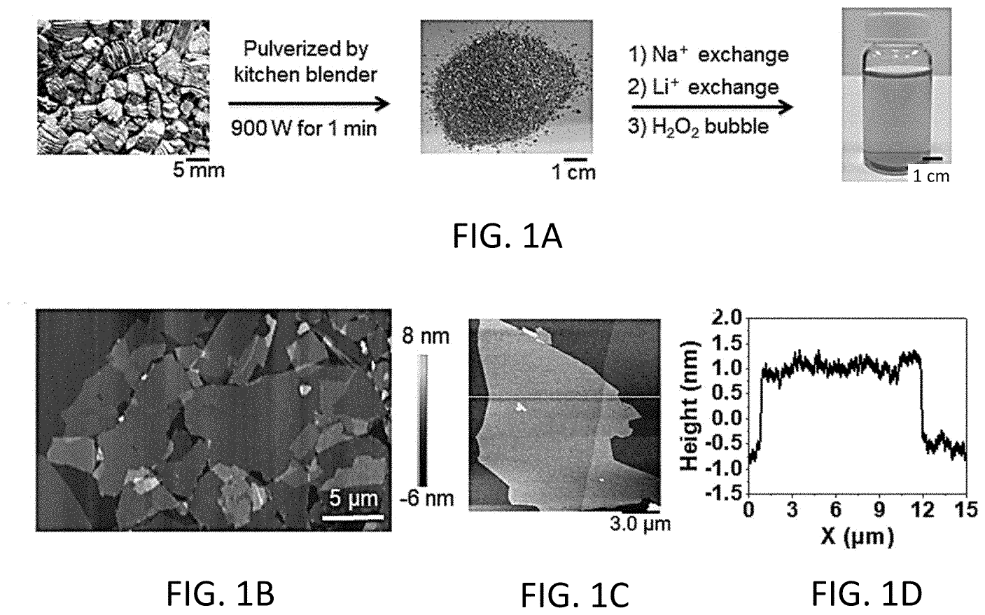

Vermiculite is a layered magnesium aluminosilicate compound with each layer composed of one Mg-based octahedral sublayer sandwiched between two tetrahedral silicate sublayers. FIG. 1A shows the exfoliation process to obtain few-layer vermiculite sheets. First, vermiculite particles were partially exfoliated by thermal shock, exhibiting accordion-like structures. This is the most common form of commercially available vermiculite, which is often sold as absorbents for solvent spills or soil conditioners for gardens. Next, the as-received thermally expanded vermiculite particles were pulverized into fine powders of tens of microns in size using a high-power kitchen blender. This increased the accessible surface areas of the powders for the ionic exchange reactions and reduced the diffusion pathways. The pulverized powders were then swollen by a two-step process involving ionic exchange reactions to replace the interlayer cations with Na⁺ and Li⁺. Finally, a hydrogen peroxide treatment was applied to further exfoliate the vermiculite particles into few-layer vermiculite sheets through the help of oxygen evolution. This mechanical-chemical exfoliation processing yielded a light yellow colloidal suspension of thin vermiculite sheets. FIG. 1B shows the atomic force microscopy (AFM) image of a film of tiled vermiculite sheets prepared by LB assembly. The sheets exhibited quite uniform thickness and large lateral dimension in the range of a few microns to a few tens of microns. In FIGS. 1C and 1D, the higher magnification AFM image of a piece of vermiculite sheet and the corresponding height profile show that the thickness of the sheet was about 1.5 nm. This corresponds to a monolayer of vermiculite.

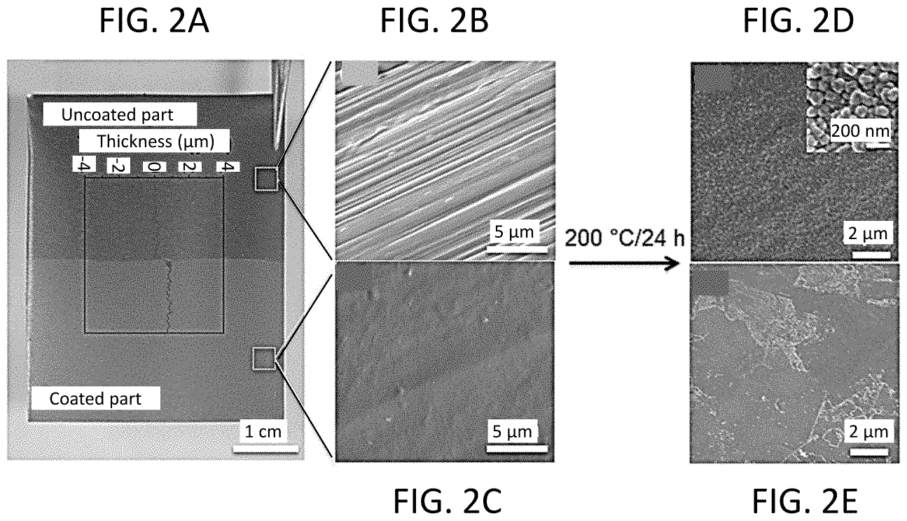

To investigate the thermal oxidation barrier properties of coatings of the vermiculite sheets, the 1 mL colloidal vermiculite dispersion (5 mg mL⁻¹) was spray-coated on Cu foils heated at 200° C. using an air spray apparatus. As shown in FIG. 2A, the coating appears uniform, continuous, and transparent, and has a thickness of ˜1 μm. FIGS. 2B and 2C show the SEM images of the Cu foil before (FIG. 2B) and after (FIG. 2C) vermiculite coating. The parallel rolling marks are quite visible on the uncoated Cu foil, which were uniformly and conformally covered by spray-coated vermiculite sheets. The surface morphology of the foil after being heated in air at various temperatures for 24 hours was examined by SEM. The uncoated part of the Cu foil was completely covered with oxide particles (˜100 nm) after heating at 200° C. in air (FIG. 2D). In contrast, no obvious change in surface morphology can be seen on the coated part (FIG. 2E). At 300° C., the bare Cu foil underwent a significant degree of oxidation. At 400° C., the foil was nearly completely destroyed. With the vermiculite coating, however, the Cu foil remained smooth and clean after heating at 200° C. and 300° C., and exhibited only a minor degree of oxidation damage at 400° C.

To further evaluate the oxidation resistance of the vermiculite coated Cu, cross-sectional SEM analysis and element mapping were carried out. The analysis showed that the Cu foil had signs of oxidation at 200° C., including many oxide flakes on both sides. When the oxidation temperature increased to 300° C., the Cu foil became much thicker due to the formation of oxide layers on both sides, which were found to be around 8.4 μm in thickness. At 400° C., extensive arrays of oxide nanowires were grown on both surfaces of the Cu foil. In contrast, vermiculite coated Cu foils did not show any thickness change after heating and no oxidation was indicated by O element mapping after heating at 300° C. for 24 hours.

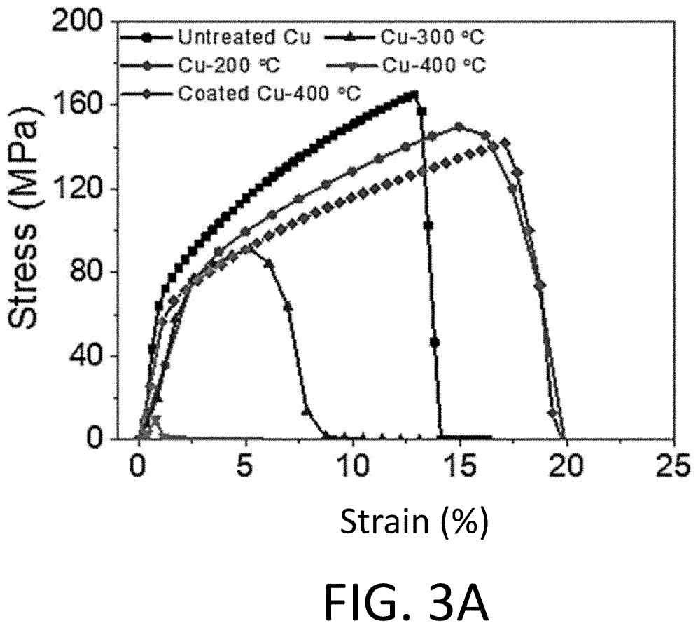

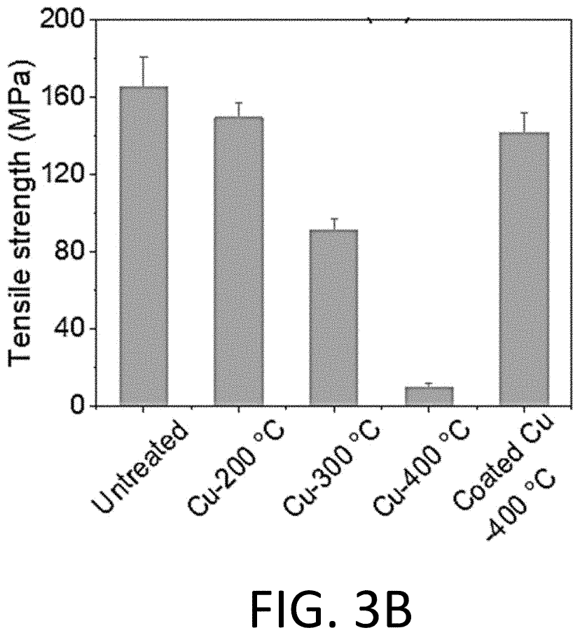

Oxidation damage can negatively affect metals' mechanical and electrical properties. Tensile tests were performed on coated and uncoated Cu foils after oxidation. Some representative tensile strain-stress curves are shown in FIG. 3A. Untreated refers to uncoated Cu foils prior to oxidation under heat. While the uncoated Cu foil can largely withstand heating at 200° C., both its tensile stress and ductility decrease sharply when annealed at 300° C. After heating at 400° C., the Cu foil had lost its tensile properties due to extensive oxidation damage. In contrast, the tensile strength of vermiculite coated Cu foils was still about 142 MPa after heating at 400° C., which is 14 times higher than that of the uncoated Cu foil treated at some conditions (FIG. 3B). It also became slightly more ductile than the starting Cu foil, which can be attributed to the effects of thermal annealing. Bending tests of uncoated and vermiculite coated Cu foils were also obtained. After heating at 400° C. for 24 hours, the uncoated Cu foil became so brittle that it broke readily upon bending, while the vermiculite coated Cu foil still exhibited good flexibility and ductility. These results demonstrate that 2D vermiculite sheets indeed worked as an excellent thermal resistant oxygen barrier coating for Cu foils. Although bulk vermiculite (e.g., the starting powders shown in FIG. 1A) with a 3D capillary porous structure can hold much water, the coating made of well-exfoliated single or few layers are dense enough to prevent penetration of water that would lead to the corrosion of metal in ambient air.

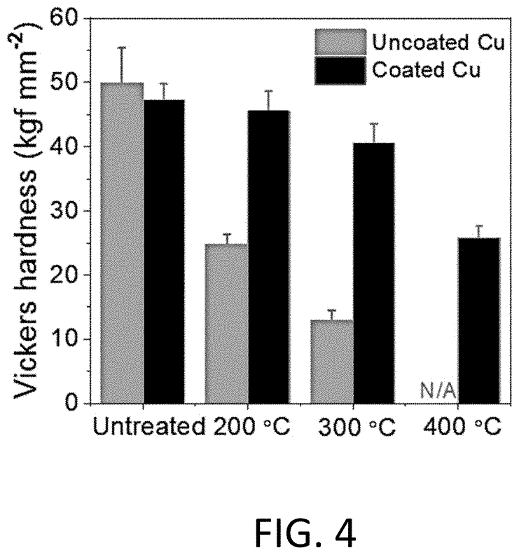

The hardnesses of the uncoated and vermiculite coated Cu foils were also measured by Vickers hardness tests. T Indentation images of the samples without heating and after annealing for 24 hours at different temperatures in air were obtained. Two diagonals of the indentation can be observed clearly on the surface after unloading, and the calculated H_{V} values are given in FIG. 4. The H_{V} of uncoated Cu decreased from 50 kgf mm⁻² to 25 kgf mm⁻² after annealing at 200° C., then dropped to 12 kgf mm⁻² after annealing at 300° C. After heating at 400° C., the Cu foil was destroyed and no H_{V} could be measured. In contrast, the vermiculite coated Cu foils maintained 86% of the original H_{V} after annealing at 300° C. Even after annealing at 400° C., the vermiculite coated Cu still exhibited a H_{V} value of about 26 kgf mm⁻², again demonstrating the excellent high-temperature oxidization barrier properties of vermiculite coatings. A similar trend was also observed for electrical conductivity. The conductance of uncoated and vermiculite coated Cu foils after heating at 200° C. in air for 24 hours remained 99% and 95% of their original values, respectively. However, when the annealing temperature was increased to 300° C., the conductance of the uncoated Cu foil decreased to only 0.002% of its original conductivity. In contrast, the conductivity of vermiculite coated Cu foil remained 93% even after heating at 400° C. for 24 hours.

### Conclusions

In conclusion, this Example shows that a colloidal dispersion of monolayer to few-layer vermiculite sheets with very high aspect ratios can be obtained in high yield using a mechanical-chemical exfoliation process. The dispersion can be spray-coated directly on Cu foils to form conformal, continuous, and transparent barrier coatings that protect Cu foils from thermal oxidation damage up to heating at 400° C. for 24 hours, minimizing the degradation in tensile strength and hardness.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A method of forming an oxidation barrier, the method comprising:
applying a clay mineral coating composition comprising a solvent and exfoliated clay mineral sheets to a surface of a substrate; and
removing solvent from the clay mineral coating composition as-applied to the surface, thereby forming a coating comprising the exfoliated clay mineral sheets on the surface.

2. The method of claim 1, wherein the exfoliated clay mineral sheets are exfoliated vermiculite sheets.

3. The method of claim 1, wherein the coating consists of the exfoliated clay mineral sheets.

4. The method of claim 3, wherein the exfoliated clay mineral sheets are exfoliated vermiculite sheets.

5. The method of claim 1, wherein the exfoliated clay mineral sheets have a thickness of from a monolayer of the clay mineral to 5 monolayers of the clay mineral.

6. The method of claim 1, wherein the exfoliated clay mineral sheets comprise at least two different types of interlayer cations.

7. The method of claim 6, wherein the exfoliated clay mineral sheets comprise three different types of interlayer cations.

8. The method of claim 7, wherein the interlayer cations comprise sodium, lithium, and magnesium.

9. The method of claim 1, further comprising forming the clay mineral coating composition by
pulverizing clay mineral particles;
exposing the pulverized clay mineral particles to a first salt solution comprising a first cation under conditions to exchange interlayer cations of the pulverized clay mineral particles with the first cation;
exposing the pulverized clay mineral particles to a second salt solution comprising a second cation under conditions to exchange interlayer cations of the pulverized clay mineral particles with the second cation, thereby forming ion exchanged clay mineral sheets; and
exposing the ion exchanged clay mineral sheets to a peroxide to form the exfoliated clay mineral sheets.

10. The method of claim 9, wherein the first salt solution comprises a sodium salt and the second salt solution comprises a lithium salt.

11. The method of claim 10, wherein the clay mineral particles are vermiculite particles.

12. The method of claim 11, wherein the vermiculite particles are thermally expanded vermiculite particles.

13. The method of claim 9, wherein the peroxide is H₂O₂.

14. The method of claim 9, wherein the first salt solution comprises a sodium salt and the second salt solution comprises a lithium salt, the clay mineral particles are thermally expanded vermiculite particles, and the peroxide is H₂O₂.

15. An oxidation barrier comprising a coating comprising exfoliated clay mineral sheets on a surface of a substrate.

16. The oxidation barrier of claim 15, wherein the exfoliated clay mineral sheets are exfoliated vermiculite sheets.

17. The oxidation barrier of claim 15, wherein the coating consists of the exfoliated clay mineral sheets.

18. The oxidation barrier of claim 17, wherein the exfoliated clay mineral sheets are exfoliated vermiculite sheets.

19. The oxidation barrier of claim 15, wherein the exfoliated clay mineral sheets have a thickness of from a monolayer of the clay mineral to 5 monolayers of the clay mineral.
